(19) United States
(12) Patent Application Publication
(10) Pub. No.: US 2025/0187397 A1
(43) Pub. Date: Jun. 12, 2025

(54) SYSTEM AND METHOD FOR SELECTIVE THERMOREGULATION OF A PLURALITY OF TEMPERATURE-CONTROLLED ENCLOSURES IN AUTOMOBILES

(71) Applicant: Chuanming Fu, Chongqing (CN)

(72) Inventors: Chuanming Fu, Chongqing (CN); Yuquan Cui, Chongqing (CN); Zhengwen Zhang, Chongqing (CN); Xiao Jin, Richmond (CN); Qifeng Zhou, Chongqing (CN); Yue Fu, Sydney (AU)

(21) Appl. No.: 18/531,473

(22) Filed: Dec. 6, 2023

(51) Int. Cl. B60H 1/00

(52) U.S. Cl. CPC B60H 1/00878; B60H 1/00985; B60H 2001/00942

(57) ABSTRACT

A system and method for selective thermoregulation of a plurality of temperature-controlled enclosures in automobiles is disclosed. The system includes primary enclosure located in exterior region of automobile, equipped with thermoregulation units and capable of storing objects for temperature control. The primary enclosure is connected, through tubular structures, to secondary enclosures positioned in interior region of the automobile. The secondary enclosures also have thermoregulation units and can receive refrigerant from primary enclosure to store objects for temperature control. Further, the system includes controlling unit that allows user to select different thermoregulation modes based on the type of objects stored in each enclosure. The controlling unit adjusts temperature of primary and secondary enclosures according to selected mode. The refrigerant supply to each enclosure is controlled by activating ports associated with valves. The controlling unit periodically monitors vehicle parameters and adjusts refrigerant supply, heat generation, and battery consumption based on vehicle conditions.

### TECHNICAL FIELD

Embodiments of the present disclosure generally relate to cooling and heating systems for automobiles and more particularly relates to a system and a method for selective thermoregulation of a plurality of temperature-controlled enclosures in automobiles.

### BACKGROUND

Generally, with the rapid advancement of new energy vehicle industry, the popularity of new energy vehicles among ordinary families has significantly increased. As a result, user expectations for vehicle practicality and comfort have also increased. Particularly during summers or snowy winters, there is a strong desire to maintain goods or food in optimal condition for extended periods. This need arises from various aspects of life, work, travel, and other activities. Currently, vehicle refrigerators have captured people's attention as a potential solution. However, most vehicle refrigerators available in the market are designed to be affixed on a surface, which adversely affects the internal spatial arrangement of the vehicle. Moreover, the current vehicle refrigerators occupy passenger seating areas, posing certain safety risks.

Conventionally, an apparatus discloses a rear-side transportation apparatus with a container situated beneath a motor car's floor panel. The conventional container comprises a storage compartment and a temperature control unit that regulates the temperature within the storage compartment. The container moves along guide rails in the longitudinal direction of the vehicle. Another conventional system provides a movable vehicle hood that allows access to the engine compartment. The closure panel houses a compartment with a lid, providing access to a storage space. The compartment includes a temperature control system for maintaining a specific temperature within the storage space. Yet another conventional system provides an electric vehicle that includes a cooling box located in the vehicle main body. The vehicle main body comprises a passenger compartment and a front accommodation compartment positioned in front of the passenger compartment. The cooling box is situated in the front accommodation compartment, enabling easy access even when the electric vehicle is parked in reverse.

Further, another conventional system provides a vehicle rear part storage structure incorporating an air conditioning mechanism to supply hot and cold air to a storage box beneath the body's rear part. It also features a cover mechanism to contain the hot and cold air within the storage box. The cover mechanism consists of a roll curtain that opens and closes the upper opening of the storage box. When the storage box slides to the rear of the vehicle from its storage position, the roll curtain is wound up, and the upper opening of the storage box is exposed. Yet another conventional system encompasses a vehicle, a vehicle refrigerator, and a method for controlling the vehicle refrigerator. The conventional control method involves switching on the vehicle refrigerator, measuring the interior temperature initially, measuring it again after a predetermined time, determining the temperature change, and activating a rapid cooling mode (quench mode) if the temperature change is positive. In another conventional system a cold storage vehicle is provided that includes a container with three storage compartments. The first compartment maintains room temperature, the second compartment maintains a lower temperature, and the third compartment maintains an even lower temperature compared to the second compartment.

However, conventional refrigeration or heating systems in vehicles are either portable or fixed on the surface of the vehicle. This not only affects internal layout of the vehicle by occupying seating or storage area, but also has certain risks. Also, items can only be stored for a short time in the refrigeration or heating systems in vehicles. Usually, users need to take out the items from the refrigerator when leaving the vehicles. Further, noise and heat from the vehicle refrigerators stay inside vehicle, causing inconvenience to the users.

Consequently, there is a need for an improved system and method for selective thermoregulation of a plurality of temperature-controlled enclosures in automobiles to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a system for selective thermoregulation of a plurality of temperature-controlled enclosures in automobiles. The system includes a primary enclosure comprised of a first plurality of thermoregulation units positioned in an exterior region of an automobile. The primary enclosure is configured to supply a varying amount of refrigerant and store one or more objects for a selective thermoregulation. The primary enclosure includes one or more values with one or more ports. Further, the system includes a plurality of secondary enclosures, coupled to the primary enclosure through one or more tubular structures associated with the one or more values and comprised of a second plurality of thermoregulation units. The plurality of secondary enclosures is configured to receive the varying amount of refrigerant from the primary enclosure and store the one or more objects for the selective thermoregulation. The plurality of secondary enclosures is positioned in at least one of a front surface and a rear surface of an interior region of the automobile.

Furthermore, the system includes a controlling unit configured to display a plurality of thermoregulation modes being selectable by a user based on a type of the one or more objects stored in each of the plurality of secondary enclosures and the primary enclosure. Further, the controlling unit is configured to vary temperature of each of the plurality of secondary enclosures and the primary enclosure, based on each of a selected mode in the plurality of thermoregulation modes for each of the plurality of secondary enclosures and the primary enclosure. Varying temperature for refrigeration is based on actuating each of one or more ports associated with each of the one or more values for controlling an amount of the refrigerant supply to each of the plurality of secondary enclosures and the primary enclosure. Further, the controlling unit is configured to periodically determine one or more vehicle parameters associated with the automobile, upon varying the temperature. Also, the controlling unit is configured to control the amount of the refrigerant supply, a heat generation for each of the plurality of secondary enclosures and the primary enclosure, and battery consumption, based on the periodically determined one or more vehicle parameters.

Another aspect of the present disclosure provides a method for selective thermoregulation of a plurality of temperature-controlled enclosures in automobiles. The method includes displaying a plurality of thermoregulation modes being selectable by a user based on a type of one or more objects stored in a primary enclosure and each of plurality of secondary enclosures. Further, the method includes varying temperature of each of the plurality of secondary enclosures and the primary enclosure, based on each of a selected mode in the plurality of thermoregulation modes for each of the plurality of secondary enclosures and the primary enclosure. Varying temperature for refrigeration is based on actuating each of one or more ports associated with each of the one or more values for controlling an amount of the refrigerant supply to each of the plurality of secondary enclosures and the primary enclosure. Furthermore, the method includes periodically determining one or more vehicle parameters associated with the automobile, upon varying the temperature. Additionally, the method includes controlling the amount of the refrigerant supply, a heat generation for each of the plurality of secondary enclosures and the primary enclosure, and battery consumption, based on the periodically determined one or more vehicle parameters.

Yet another aspect of the present disclosure provides a non-transitory computer-readable storage medium having programmable instructions stored therein. That when executed by one or more hardware processors cause the one or more hardware processors to display a plurality of thermoregulation modes being selectable by a user based on a type of the one or more objects stored in primary enclosure and each of plurality of secondary enclosures. Further, the one or more hardware processors vary temperature of each of the plurality of secondary enclosures and the primary enclosure, based on each of a selected mode in the plurality of thermoregulation modes for each of the plurality of secondary enclosures and the primary enclosure. Varying temperature for refrigeration is based on actuating each of one or more ports associated with each of the one or more values for controlling an amount of the refrigerant supply to each of the plurality of secondary enclosures and the primary enclosure. Further, the one or more hardware processors periodically determine one or more vehicle parameters associated with the automobile, upon varying the temperature. Additionally, the one or more hardware processors control the amount of the refrigerant supply, a heat generation for each of the plurality of secondary enclosures and the primary enclosure, and battery consumption, based on the periodically determined one or more vehicle parameters.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1 illustrates an exemplary block diagram representation of a system for selective thermoregulation of a plurality of temperature-controlled enclosures in automobiles, in accordance with an embodiment of the present disclosure;

FIG. 2 illustrates an exemplary block diagram representation of a computer-implemented controlling unit, such as those shown in FIG. 1, capable of selective thermoregulation of a plurality of temperature-controlled enclosures in automobiles, in accordance with an embodiment of the present disclosure;

FIG. 3A illustrates a perspective view of an exemplary primary enclosure, in accordance with an embodiment of the present disclosure;

FIG. 3B illustrates a perspective view of an exemplary secondary enclosure, in accordance with an embodiment of the present disclosure;

FIG. 3C illustrates an exploded view of an exemplary primary enclosure, in accordance with an embodiment of the present disclosure; and

FIG. 4 illustrates a flow chart depicting a method of selective thermoregulation of a plurality of temperature-controlled enclosures in automobiles, in accordance with the embodiment of the present disclosure.

Further, those skilled in the art will appreciate that elements in the figures are illustrated for simplicity and may not have necessarily been drawn to scale.

Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client, or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

Embodiments of the present disclosure provide a system and a method for selective thermoregulation of a plurality of temperature-controlled enclosures in automobiles. The system and method described herein are designed for refrigerating or heating storage compartments in the automobiles. This refrigerating or heating solution is particularly advantageous for cooling and heating consumables/objects such as food and beverages during travel. However, it should be noted that the same system and method can be applied to other vehicles, aircrafts, or systems without deviating from the core principles of the present invention. In this context, the system and method can be utilized in various vehicles or systems that can provide a cold heat sink, similar to the concept explained below. One of the key benefits of the present disclosure is its versatility, allowing for different operating modes to achieve cost-effective and efficient refrigeration/heating of the enclosures. Further, the system of the present disclosure recognizes the temperature intelligent control of the storage space of the automobile and does not affect the pattern and safety of the vehicle. Further, the system of the present disclosure discharges the noise and heat outside the cabin of the automobile. The system of the present disclosure intelligently controls the compressor to provide cooling capacity for single and multiple storage spaces at the same time.

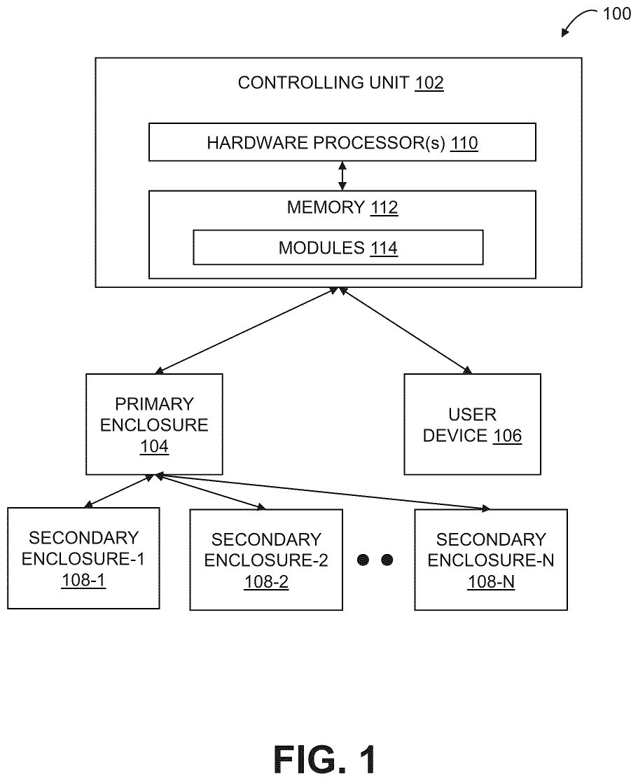

Referring now to the drawings, and more particularly to FIG. 1 through FIG. 4, where similar reference characters denote corresponding features consistently throughout the figures, there are shown preferred embodiments and these embodiments are described in the context of the following exemplary system and/or method.

FIG. 1 illustrates an exemplary block diagram representation of a system 100 for selective thermoregulation of a plurality of temperature-controlled enclosures in automobiles, in accordance with an embodiment of the present disclosure.

According to FIG. 1, the system 100 may include a controlling unit 102, a primary enclosure 104, a user device 106, and a plurality of secondary enclosures 108-1, 108-2, . . . , and 108-N (individually referred to as the secondary enclosure 108, and collectively referred to as the secondary enclosures 108). The controlling unit 102 may be communicatively coupled to the user device 106 via a communication network (not shown). The communication network may be a wired communication network and/or a wireless communication network.

Further, the user device 106 may be associated with, but not limited to, a user, an individual, an administrator, a vendor, a technician, a worker, a specialist, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the controlling unit 102. The user device 106 may present to the user one or more user interfaces for the user to interact with the controlling unit 102 for selective thermoregulation automobiles needs. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the controlling unit 102 may be implemented by way of a single device or a combination of multiple devices that may be operatively connected or networked together. The controlling unit 102 may be implemented in hardware or a suitable combination of hardware and software. The controlling unit 102 includes one or more hardware processor(s) 110, and a memory 112. The memory 112 may include a plurality of modules 114. The controlling unit 102 may be a hardware device including the hardware processor 110 executing machine-readable program instructions for selective thermoregulation of a plurality of temperature-controlled enclosures in automobiles. Execution of the machine-readable program instructions by the hardware processor 110 may enable the proposed controlling unit 102 to selective thermoregulate a plurality of temperature-controlled enclosures in automobiles. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the controlling unit 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, network devices, databases, network attached storage devices, assets, machinery, instruments, facility equipment, emergency management devices, image capturing devices, cooling devices, heating devices, compressors, any other devices, and combination thereof. The person skilled in the art should not be limiting the components/subsystems shown in FIG. 1.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, Bluetooth adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the controlling unit 102 as is unique to the present disclosure or necessary for an understanding of the present disclosure is depicted and described. The remainder of the construction and operation of the controlling unit 102 may conform to any of the various current implementations and practices that were known in the art.

In an exemplary embodiment, the system 100 may include the primary enclosure 104. The primary enclosure 104 may include a first plurality of thermoregulation units (not shown in FIG. 1) positioned in an exterior region of an automobile (not shown in FIG. 1), The first plurality of thermoregulation units includes, but are not limited to, at least one of a control panel, an inner container, an evaporator, an electrothermal film, an insulation layer, an outer container, a condenser, a cooling fan, a filter, a three-way/four-way valve, a heating resistor, a shockproof elements, a compressor, and the like. The primary enclosure 104 may be configured to supply a varying amount of refrigerant and store one or more objects for a selective thermoregulation. The primary enclosure includes one or more values with one or more ports (not shown in FIG. 1). The compressor, the condenser, and the cooling fan are disposed in the primary enclosure and positioned in an exterior region of an automobile to discharge the noise and heat outside a driving room of the automobile.

In an exemplary embodiment, the system 100 may include the plurality of secondary enclosures 108, coupled to the primary enclosure 104 through one or more tubular structures (not shown in FIG. 1) associated with the one or more values. The plurality of secondary enclosures 108 includes a second plurality of thermoregulation units (not shown). The second plurality of thermoregulation units include, but are not limited to, an inner container, an evaporator, an electrothermal film, an insulation layer, an outer container, a heating resistor, a shockproof element, a cover, and the like. Each of the plurality of secondary enclosures 108 and the primary enclosure 104 may be wounded with the one or more tubular structures (not shown in FIG. 1) that function as evaporators to cool down air and the objects, when operating in a cold mode of the plurality of thermoregulation modes. The plurality of secondary enclosures 108 may be configured to receive the varying amount of refrigerant from the primary enclosure 104 and store the one or more objects for the selective thermoregulation. The plurality of secondary enclosures 108 may be positioned in at least one of a front surface and a rear surface of an interior region of the automobile. Each of the plurality of secondary enclosures 108 and the primary enclosure 104 may include a plurality of electrothermal films (not shown in FIG. 1) to heat up the air and the objects, through electricity, when operating in a heat mode of the plurality of thermoregulation modes.

In an exemplary embodiment, the system 100 may include the controlling unit 102. The controlling unit 102 may be configured to display a plurality of thermoregulation modes being selectable by a user based on a type of the one or more objects stored in each of the plurality of secondary enclosures and the primary enclosure. The plurality of thermoregulation modes includes, but are not limited to, a beverage mode, a vegetable mode, an anti-freezing mode, an anti-burned by high-temperature mode, an anti-rotten by high-temperature mode, a custom mode, and the like. Furthermore, the controlling unit 102 may vary temperature of each of the plurality of secondary enclosures and the primary enclosure, based on each of a selected mode in the plurality of thermoregulation modes for each of the plurality of secondary enclosures and the primary enclosure. Varying temperature for refrigeration is based on actuating each of one or more ports associated with each of the one or more values for controlling an amount of the refrigerant supply to each of the plurality of secondary enclosures and the primary enclosure. Additionally, the controlling unit 102 may periodically determine one or more vehicle parameters associated with the automobile, upon varying the temperature. The one or more vehicle parameters includes, but are not limited to, a battery capacity of the automobile, operation time, internal temperature of the automobile, external temperatures of the automobile, and the like. Further, the controlling unit 102 may control the amount of the refrigerant supply, a heat generation for each of the plurality of secondary enclosures and the primary enclosure, and battery consumption, based on the periodically determined one or more vehicle parameters. For example, the intelligent control panel automatically adjusts the temperature, switch to energy saving mode based on the mode chosen by the user, remaining battery capacity of the vehicle, working hours and temperature of inside and/or outside of the vehicle.

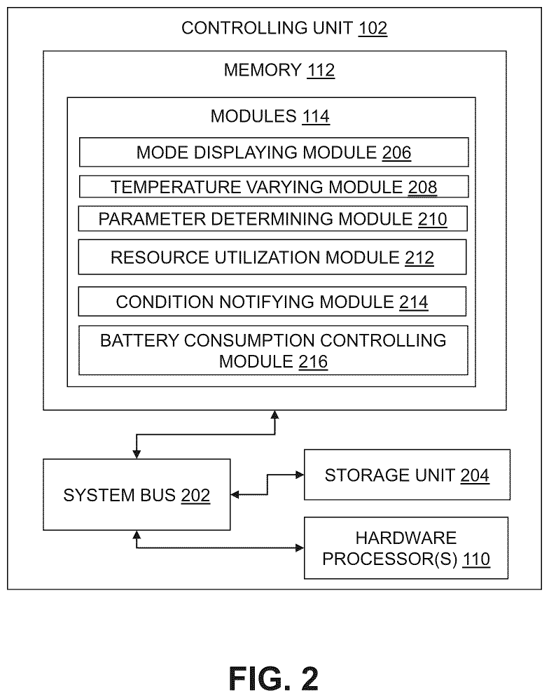

FIG. 2 illustrates an exemplary block diagram representation of a computer-implemented controlling unit 102, such as those shown in FIG. 1, capable of selective thermoregulation of a plurality of temperature-controlled enclosures in automobiles, in accordance with an embodiment of the present disclosure. The controlling unit 102 may also function as a computer-implemented system/controlling unit 102 (hereinafter referred to as the controlling unit 102). The controlling unit 102 includes the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

Further, the plurality of modules 114 includes a mode displaying module 206, a temperature varying module 208, a parameter determining module 210, a resource utilization module 212, a condition notifying module 214, and a battery consumption controlling module 216.

The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a database. The storage unit 204 may store, but is not limited to, application data, metadata, output data, vehicle parameters, thermoregulation modes, any other data, and combinations thereof. The storage unit 204 may be any kind of database such as, but are not limited to, relational databases, dedicated databases, dynamic databases, monetized databases, scalable databases, cloud databases, distributed databases, any other databases, and a combination thereof.

In an exemplary embodiment, the mode displaying module 206 may be configured to display a plurality of thermoregulation modes being selectable by a user based on a type of the one or more objects stored in each of the plurality of secondary enclosures 108 and the primary enclosure 104. The plurality of thermoregulation modes includes, but are not limited to, a beverage mode, a vegetable mode, an anti-freezing mode, an anti-burned by high-temperature mode, an anti-rotten by high-temperature mode, a custom mode, and the like.

In an exemplary embodiment, the temperature varying module 108 may be configured to vary temperature of each of the plurality of secondary enclosures 108 and the primary enclosure 104, based on each of a selected mode in the plurality of thermoregulation modes for each of the plurality of secondary enclosures 108 and the primary enclosure 104. Varying temperature for refrigeration is based on actuating each of one or more ports associated with each of the one or more values for controlling an amount of the refrigerant supply to each of the plurality of secondary enclosures 108 and the primary enclosure 104.

In an exemplary embodiment, the parameter determining module 210 may be configured to periodically determine one or more vehicle parameters associated with the automobile, upon varying the temperature. The one or more vehicle parameters includes, but are not limited to, a battery capacity of the automobile, operation time, internal temperature of the automobile, external temperatures of the automobile, and the like.

In an exemplary embodiment, the resource utilization module 212 may be configured to control the amount of the refrigerant supply, a heat generation for each of the plurality of secondary enclosures 108 and the primary enclosure 104, and battery consumption, based on the periodically determined one or more vehicle parameters.

In an exemplary embodiment, the condition notifying module 214 may be configured to output at least one of notifications and reminders on the user device 106 associated with the user and a display (not shown) associated with the automobile, regarding current conditions of each of the plurality of secondary enclosures 108 and the primary enclosure 104, and in an event of unexpected condition of the automobile. The unexpected condition of the automobile includes, but is not limited to, a battery deficiency, a perception sensor breakdown, a cooling function failure, a heating function failure, an operation failure of each of the plurality of secondary enclosures 108 and the primary enclosure 104 due to extreme weather, and the like.

In an exemplary embodiment, the battery consumption controlling module 216 may be configured to control a battery consumption when the automobile is not in operation. In an exemplary embodiment, the a mode displaying module 206 may store at least one of a selection, a modification, an addition, and a routine of the plurality of thermoregulation modes. For example, the user can edit and save the plurality of thermoregulation modes to preferable temperatures.

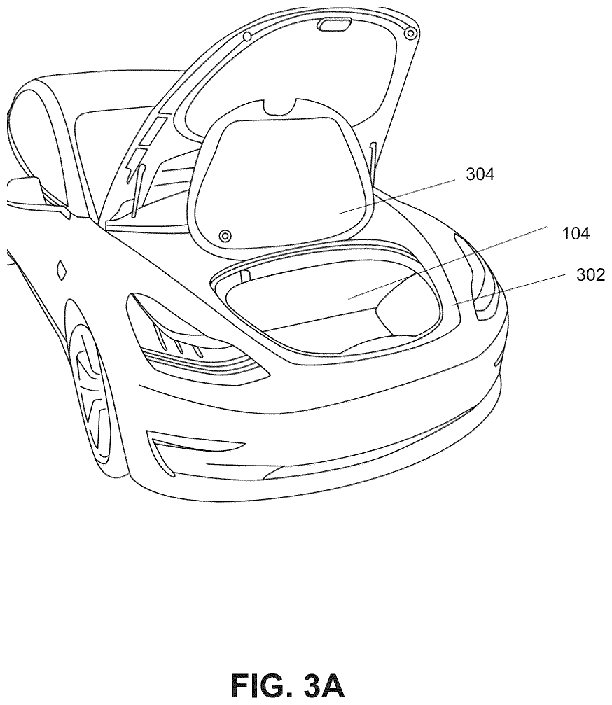

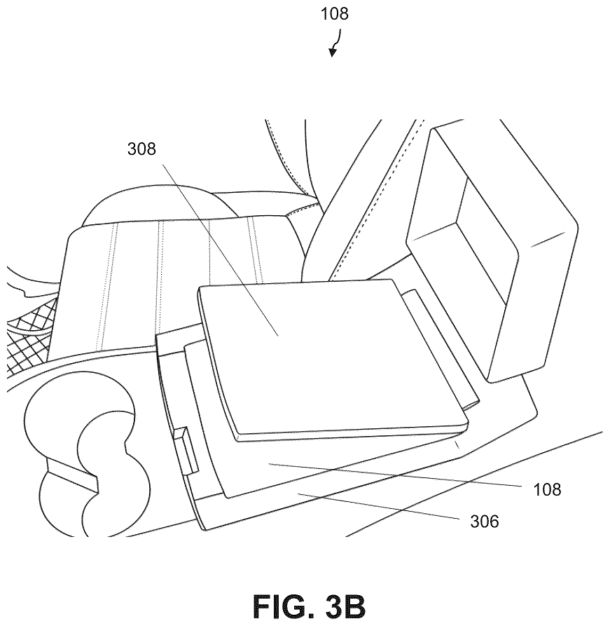

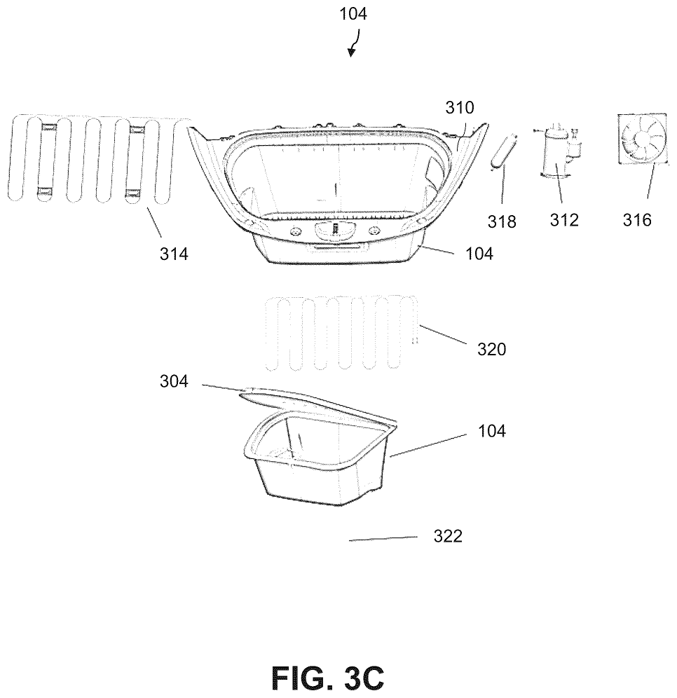

FIG. 3A illustrates a perspective view of an exemplary primary enclosure 104, in accordance with an embodiment of the present disclosure. The primary enclosure 101 is located in a front spare box 302 of the automobile. The primary enclosure 101 may include a door 304. The secondary enclosures 108 shown in FIG. 3B may be located in, but not limited to, a front armrest box 306, a passenger room in the automobile, a built-in box in the middle of a rear seat back, and the like. The secondary enclosures 108 may include a secondary enclosure door 308. The secondary enclosures 108 may be located in any storage space (e.g., in the driver's cab of the vehicle), and the primary enclosure 101 and the secondary enclosures 108 may include anti-vibration devices or shockproof device that can prevent the objects in the box from colliding due to road bumps or braking.

FIG. 3C illustrates an exploded view of an exemplary primary enclosure 104, in accordance with an embodiment of the present disclosure. The controlling unit 102 may include a control panel 310 with a user interface for the user. A compressor 312, the condenser 314, and a cooling fan 316 are placed on the primary enclosure 104 to discharge the noise and heat outside the driving room of the automobile.

The control panel 310 may be connected to, for example, an application associated with a mobile phone through for example, a Bluetooth and/or a subscriber identification module (SIM) card to recognize a remote control of the controlling unit 102.

Further, the refrigeration and heating principles of the intelligent temperature control storage space such as the system 100 of the vehicle includes the compressor 312 is connected to the condenser 314, a filter 318, and an evaporator 320 in order to form a cycle. The cooling fan 316 is installed on the condenser 314. The evaporator 320 (e.g., copper tubes) may be tightly wound around the primary enclosure 104 and the secondary enclosure 108. A heating resistor 322 may be placed close to the bottom of the primary enclosure 104 and the secondary enclosure 108.

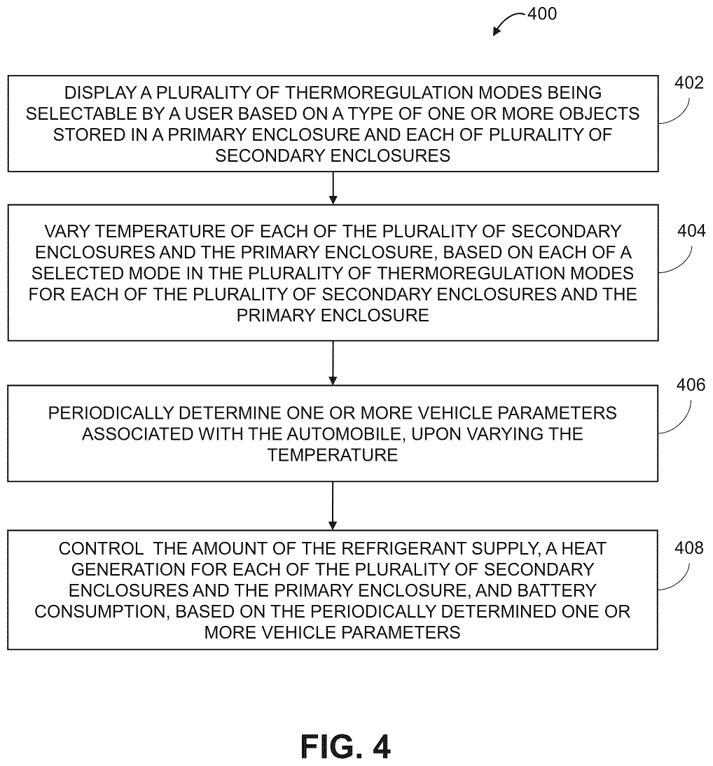

FIG. 4 illustrates a flow chart depicting a method 400 of selective thermoregulation of a plurality of temperature-controlled enclosures in automobiles, in accordance with the embodiment of the present disclosure.

At block 402, the method 400 may include displaying, by one or more hardware processors 110, a plurality of thermoregulation modes being selectable by a user based on a type of one or more objects stored in the primary enclosure 104 and each of plurality of secondary enclosures 108.

At block 404, the method 400 may include varying, by the one or more hardware processors 110, temperature of each of the plurality of secondary enclosures 108 and the primary enclosure 104, based on each of a selected mode in the plurality of thermoregulation modes for each of the plurality of secondary enclosures 108 and the primary enclosure 104. Varying temperature for refrigeration is based on actuating each of one or more ports associated with each of the one or more values for controlling an amount of the refrigerant supply to each of the plurality of secondary enclosures and the primary enclosure.

At block 406, the method 400 may include periodically determining, by the one or more hardware processors 110, one or more vehicle parameters associated with the automobile, upon varying the temperature.

At block 408, the method 400 may include controlling, by the one or more hardware processors 110, the amount of the refrigerant supply, a heat generation for each of the plurality of secondary enclosures 108 and the primary enclosure 104, and battery consumption, based on the periodically determined one or more vehicle parameters.

The method 400 may be implemented in any suitable hardware, software, firmware, or combination thereof. The order in which the method 400 is described is not intended to be construed as a limitation, and any number of the described method blocks may be combined or otherwise performed in any order to implement the method 400 or an alternate method. Additionally, individual blocks may be deleted from the method 400 without departing from the spirit and scope of the present disclosure described herein. Furthermore, the method 400 may be implemented in any suitable hardware, software, firmware, or a combination thereof, that exists in the related art or that is later developed. The method 400 describes, without limitation, the implementation of the controlling unit 102. A person of skill in the art will understand that method 400 may be modified appropriately for implementation in various manners without departing from the scope and spirit of the disclosure.

For the sake of brevity, the construction, and operational features of the controlling unit 102 which are explained in detail above are not explained in detail herein. Particularly, computing machines such as but not limited to internal/external server clusters, quantum computers, desktops, laptops, smartphones, tablets, and wearables may be used to execute the controlling unit 102 or may include the structure of a hardware platform. As illustrated, the hardware platform may include additional components not shown, and some of the components described may be removed and/or modified. For example, a computer system with multiple GPUs may be located on external-cloud platforms including Amazon Web Services, internal corporate cloud computing clusters, or organizational computing resources.

The hardware platform may be a computer system such as the controlling unit 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data. For example, the plurality of modules 114 includes a mode displaying module 206, a temperature varying module 208, a parameter determining module 210, a resource utilization module 212, a condition notifying module 214, and a battery consumption controlling module 216.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed. The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input device may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data sources interface to access the data source. The data source may be an information resource. As an example, a database of exceptions and rules may be provided as the data source. Moreover, knowledge repositories and curated data may be other examples of the data source.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

1. A system for selective thermoregulation of a plurality of temperature-controlled enclosures in automobiles, the system comprising:
a primary enclosure comprised of a first plurality of thermoregulation units positioned in an exterior region of an automobile, configured to supply a varying amount of refrigerant and store one or more objects for a selective thermoregulation, wherein the primary enclosure comprises one or more values with one or more ports;
a plurality of secondary enclosures, coupled to the primary enclosure through one or more tubular structures associated with the one or more values and comprised of a second plurality of thermoregulation units, configured to receive the varying amount of refrigerant from the primary enclosure and store the one or more objects for the selective thermoregulation; wherein the plurality of secondary enclosures is positioned in at least one of a front surface and a rear surface of an interior region of the automobile;
a controlling unit comprising one or more hardware processors, and a memory coupled to the one or more hardware processors, wherein the memory comprises a plurality of modules in form of a of programmable instructions executable by the one or more hardware processors, wherein the plurality of modules comprises:
a mode displaying module configured to display a plurality of thermoregulation modes being selectable by a user based on a type of the one or more objects stored in each of the plurality of secondary enclosures and the primary enclosure;
a temperature varying module configured to vary temperature of each of the plurality of secondary enclosures and the primary enclosure, based on each of a selected mode in the plurality of thermoregulation modes for each of the plurality of secondary enclosures and the primary enclosure, wherein varying temperature for refrigeration is based on actuating each of one or more ports associated with each of the one or more values for controlling an amount of the refrigerant supply to each of the plurality of secondary enclosures and the primary enclosure;
a parameter determining module configured to periodically determine one or more vehicle parameters associated with the automobile, upon varying the temperature; and
a resource utilization module configured to control the amount of the refrigerant supply, a heat generation for each of the plurality of secondary enclosures and the primary enclosure, and battery consumption, based on the periodically determined one or more vehicle parameters.

2. The system of claim 1, wherein the plurality of modules further comprises:
a condition notifying module configured to output at least one of notifications and reminders on a user device associated with the user and a display associated with the automobile, regarding current conditions of each of the plurality of secondary enclosures and the primary enclosure, and in an event of unexpected condition of the automobile.

3. The system of claim 1, wherein the plurality of modules further comprises:
a battery consumption controlling module configured to control a battery consumption when the automobile is not in operation.

4. The system of claim 2, wherein the unexpected condition of the automobile comprises at least one of a battery deficiency, a perception sensor breakdown, a cooling function failure, a heating function failure, and an operation failure of each of the plurality of secondary enclosures and the primary enclosure due to extreme weather.

5. The system of claim 1, wherein the one or more vehicle parameters comprises at least one of a battery capacity of the automobile, operation time, internal temperature of the automobile, and external temperatures of the automobile.

6. The system of claim 1, wherein the plurality of thermoregulation modes comprises at least one of a beverage mode, a vegetable mode, an anti-freezing mode, an anti-burned by high-temperature mode, an anti-rotten by high-temperature mode, and a custom mode.

7. The system of claim 1, wherein the first plurality of thermoregulation units comprises at least one of a control panel, an inner container, an evaporator, an electrothermal film, an insulation layer, an outer container, a condenser, a cooling fan, a filter, a three-way/four-way valve, a heating resistor, a shockproof elements, and a compressor, wherein the compressor, the condenser, and the cooling fan are disposed in the primary enclosure and positioned in an exterior region of an automobile to discharge the noise and heat outside a driving room of the automobile.

8. The system of claim 1, wherein the second plurality of thermoregulation units comprises at least one of an inner container, an evaporator, an electrothermal film, an insulation layer, an outer container, a heating resistor, a shockproof element, and a cover.

9. The system of claim 1, wherein each of the plurality of secondary enclosures and the primary enclosure is wounded with the one or more tubular structures that function as evaporators to cool down air and the objects, when operating in a cold mode of the plurality of thermoregulation modes.

10. The system of claim 1, wherein each of the plurality of secondary enclosures and the primary enclosure comprises a plurality of electrothermal films to heat up the air and the objects, through electricity, when operating in a heat mode of the plurality of thermoregulation modes.

11. A method for selective thermoregulation of a plurality of temperature-controlled enclosures in automobiles, the method comprising:
displaying, by one or more hardware processors, a plurality of thermoregulation modes being selectable by a user based on a type of one or more objects stored in a primary enclosure and each of plurality of secondary enclosures;
varying, by the one or more hardware processors, temperature of each of the plurality of secondary enclosures and the primary enclosure, based on each of a selected mode in the plurality of thermoregulation modes for each of the plurality of secondary enclosures and the primary enclosure, wherein varying temperature for refrigeration is based on actuating each of one or more ports associated with each of the one or more values for controlling an amount of the refrigerant supply to each of the plurality of secondary enclosures and the primary enclosure;
periodically determining, by the one or more hardware processors, one or more vehicle parameters associated with the automobile, upon varying the temperature; and
controlling, by the one or more hardware processors, the amount of the refrigerant supply, a heat generation for each of the plurality of secondary enclosures and the primary enclosure, and battery consumption, based on the periodically determined one or more vehicle parameters.

12. The method of claim 11 further comprising:
outputting, by the one or more hardware processors, at least one of notifications and reminders on a user device associated with the user and a display associated with the automobile, regarding current conditions of each of the plurality of secondary enclosures and the primary enclosure, and in an event of unexpected condition of the automobile.

13. The method of claim 11 further comprising:
controlling, by the one or more hardware processors, a battery consumption, when the automobile is not in operation.

14. The method of claim 12, wherein the unexpected condition of the automobile comprises at least one of a battery deficiency, a perception sensor breakdown, a cooling function failure, a heating function failure, and an operation failure of each of the plurality of secondary enclosures and the primary enclosure due to extreme weather.

15. The method of claim 11, wherein the one or more vehicle parameters comprises at least one of a battery capacity of the automobile, operation time, internal temperature of the automobile, and external temperatures of the automobile.

16. The method of claim 11, wherein the plurality of thermoregulation modes comprises at least one of a beverage mode, a vegetable mode, an anti-freezing mode, an anti-burned by high-temperature mode, an anti-rotten by high-temperature mode, and a custom mode.

17. A non-transitory computer-readable storage medium having programmable instructions stored therein, that when executed by one or more hardware processors, cause the one or more hardware processors to:
display a plurality of thermoregulation modes being selectable by a user based on a type of the one or more objects stored in primary enclosure and each of plurality of secondary enclosures;
vary temperature of each of the plurality of secondary enclosures and the primary enclosure, based on each of a selected mode in the plurality of thermoregulation modes for each of the plurality of secondary enclosures and the primary enclosure, wherein varying temperature for refrigeration is based on actuating each of one or more ports associated with each of the one or more values for controlling an amount of the refrigerant supply to each of the plurality of secondary enclosures and the primary enclosure;
periodically determine one or more vehicle parameters associated with the automobile, upon varying the temperature; and
control the amount of the refrigerant supply, a heat generation for each of the plurality of secondary enclosures and the primary enclosure, and battery consumption, based on the periodically determined one or more vehicle parameters.

18. The non-transitory computer-readable storage medium of claim 17, wherein the one or more hardware processors are further configured to:
output at least one of notifications and reminders on a user device associated with the user and a display associated with the automobile, regarding current conditions of each of the plurality of secondary enclosures and the primary enclosure, and in an event of unexpected condition of the automobile.

19. The non-transitory computer-readable storage medium of claim 17, wherein the one or more hardware processors are further configured to:
control a battery consumption when the automobile is not in operation.

20. The non-transitory computer-readable storage medium of claim 17, wherein the one or more hardware processors are further configured to:
store at least one of a selection, a modification, an addition, and a routine of the plurality of thermoregulation modes.
